(19) United States
(12) Patent Application Publication
(10) Pub. No.: US 2007/0106538 A1
(43) Pub. Date: May 10, 2007

(54) Employing user interaction to generate health care rewards

(75) Inventors: John W. Holtermann, Gig Harbor, WA (US); Adam E. Lynch, Tualatin, OR (US); William S. McKinney, Lake Oswego, OR (US); Jared L. Short, La Center, WA (US)

Correspondence Address: DARBY & DARBY P.C., P. O. BOX 5257, NEW YORK, NY, 10150-5257, US

(73) Assignee: The Regence Group, Portland, OR (US)

(21) Appl. No.: 11/269,087

(22) Filed: Nov. 8, 2005

(51) Int. Cl. G06Q 40/00

(52) U.S. Cl. 705/4

(57) ABSTRACT

The invention provides for customizing the presentation of healthcare insurance information and wellness information for a healthcare insurance subscriber. This customized information can be presented at a website, which can include, but is not limited to, claims (paid, pending and denied), referral status, answers to frequently asked questions (FAQs), explanations of benefits and wellness articles. The presented information can be customized for a subscriber based on a plurality of factors, including, but not limited to, a profile, historical behavior, age, preference, occupation, gender, family status, locale, and the like. Additionally, a reward can be provided for actions that are determined to contribute to healthcare knowledge and/or wellness of a particular subscriber. This reward can take the form of, but is not limited to, coupons, gift certificates, rebates, frequent flyer miles, discounts, prizes, money, rebates, ring tones, music, pictures, screensavers, and the like.

### FIELD OF THE INVENTION

The invention is directed to providing health care information to users, and more particularly, to providing rewards for affirmative actions related to a user's healthcare.

### BACKGROUND OF THE INVENTION

In the past, specific information regarding a healthcare insurance subscriber's wellness options and insurance transactions has been difficult to locate, access, and/or understand. Typically, an subscriber had to collect general wellness information from a variety of sources and interpret that information in regard to their own personal health issues. Also, this information was often presented without identifying which wellness options would be covered by a subscriber's insurance.

Historically, most healthcare insurance companies have not focused on providing relatively easy access to information regarding specific transactions, costs and benefits for a particular subscriber. Most subscriber's glean information regarding their insurance coverage by an awkward comparison of generic insurance information presented in a benefits brochure to specific invoices for their particular healthcare transactions. Additionally, many healthcare insurance companies have not provided economic incentives for affirmative actions related to healthcare insurance benefits and wellness information gathering.

Recent research has shown that healthcare insurance subscribers that utilize healthcare information resources and/or participate in wellness activities tend to be better consumers of healthcare. However, until now subscribers have not had access to a convenient interface for gathering personalized wellness and healthcare information or receiving rewards for their affirmative healthcare actions.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Invention, which is to be read in association with the accompanying drawings, wherein:

FIG. 1 illustrates an overview of an exemplary system for implementing a healthcare services web site;

FIG. 2 shows an overview of an exemplary framework for implementing a healthcare services web site;

FIG. 3 illustrates an overview of an exemplary healthcare services server layer;

FIG. 4 shows an overview of an exemplary arrangement of software modules for implementing the functionality of the healthcare services web site;

FIG. 5 illustrates a flow chart of a process for determining and accumulating redeemable points based on a subscriber's actions;

FIG. 6 shows a flow chart of a process for redeeming a reward based on points earned by a subscriber's actions;

FIG. 7 illustrates a flow chart of a process for updating content and redeemable rewards for a healthcare services web site based in part on affirmative interactions by a subscriber; and

FIG. 8 shows a graphical calendar interface that is customizable to a particular subscriber, in accordance with the invention.

### DETAILED DESCRIPTION OF THE INVENTION

The present invention will now be described more fully hereinafter with reference to the accompanying drawings, which form a part hereof, and which show, by way of illustration, specific exemplary embodiments by which the invention may be practiced. The invention may, however, be embodied in many different forms and should not be regarded as limited to the embodiments set forth herein. Rather, these embodiments are provided so that this disclosure will be thorough and complete and will convey fully the scope of the invention to those skilled in the art. The following detailed description is, therefore, not to be taken in a limiting sense.

Briefly, the invention is directed to customizing the presentation of healthcare insurance information and wellness information for a healthcare insurance subscriber. In one embodiment this customized information is presented at a website, which can include, but is not limited to, claims (paid, pending and denied), referral status, answers to frequently asked questions (FAQs), explanations of benefits and wellness articles. The presented information can be customized for a subscriber based on a plurality of factors, including, but not limited to, a profile, historical behavior, age, preference, occupation, gender, family status, locale, and the like.

Additionally, a reward can be provided for actions that are determined to contribute to healthcare knowledge and/or wellness of a particular subscriber. This reward can take the form of, but is not limited to, coupons, gift certificates, rebates, frequent flyer miles, discounts, prizes, money, rebates, ring tones, music, pictures, screensavers, and the like. Rewards can be redeemed immediately or stored/accumulated over time for redeeming at a later date.

In one embodiment, a calendar is provided for indicating healthcare insurance dates, customized wellness activity dates, and/or points corresponding to a particular subscriber. The healthcare insurance dates can include premium due date(s), policy renewal date, receipt of healthcare provider invoices and/or premiums, payment of healthcare provider invoices, and the like. Also, the calendar could also provide information the status of a flexible spending account for healthcare/wellness products and services.

In yet another embodiment, a rating interface is provided for a subscriber to both rate and learn about the ratings provided by others regarding healthcare facilities such as hospitals and clinics, and healthcare professionals, such as doctors.

In still another embodiment, a transaction interface is provided for enabling the subscriber to view financial information regarding payments to healthcare facilities and professionals, pending invoices for payment, premium payment history, benefit payment history, and the like.

Illustrative Operating Environment

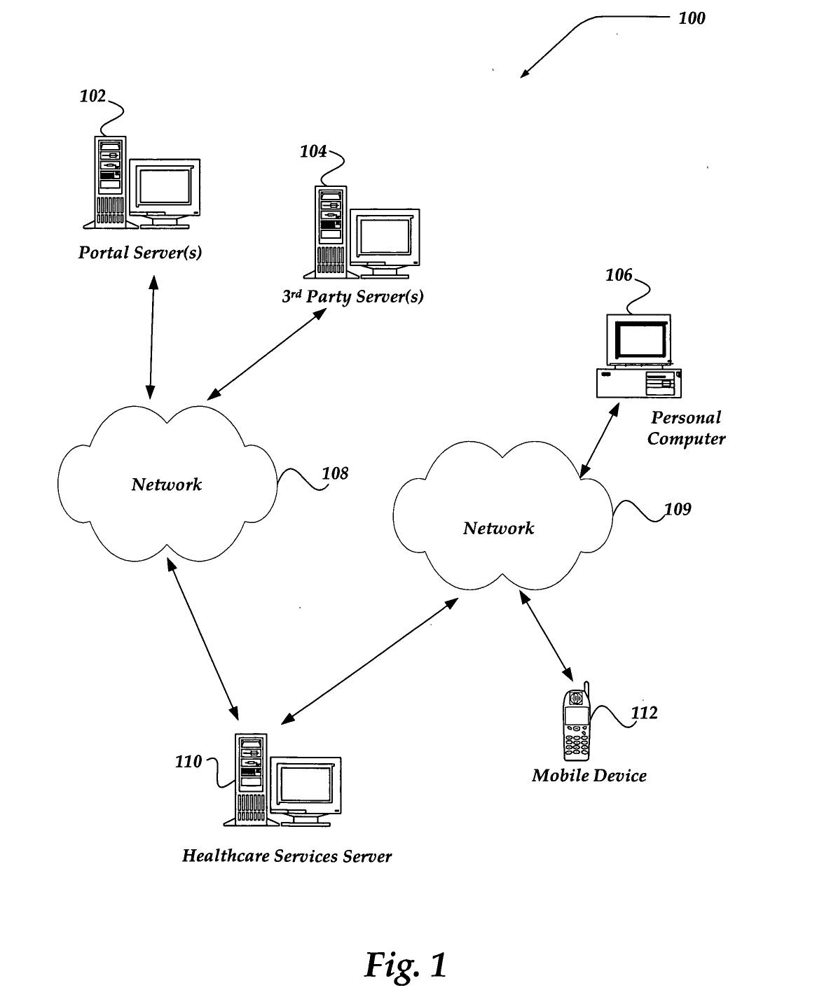

FIG. 1 illustrates one embodiment of an environment in which the invention may operate. However, not all of these components may be required to practice the invention. Variations in the arrangement and type of the components may be made without departing from the spirit or scope of the invention.

As illustrated in FIG. 1, system 100 includes Healthcare services server 110 which provides a platform for healthcare insurance information and wellness information that is accessible to subscribers. System 100 further includes portal server 102 and third-party server 104 which are in communication with health care services server 110 by way of network 108. Moreover, third-party server 104 may be in communication with portal server 102 by way of network 108. It will be understood that health care services server 110 and portal server 102 may represent several computing devices, and that many third-party servers such as third-party server 104 may be included in the system. Network 108 may be regarded as a private network connection and may include, for example, a virtual private network or an encryption or other security mechanism employed over the public Internet.

System 100 also includes devices operated by subscribers and running browser applications or the like, including wired computing device 106 (depicted as a personal computer) and wireless mobile device 112. Such devices are in communication with healthcare services server 110 by way of network 109. Network 109 may be the public Internet and may include all or part of network 108; network 108 may include all or part of network 109.

Portal server 102, third-party server 104, healthcare services server 110, wired computing device 106, and mobile device 112 each represent computing devices which may generally include virtually any device that is configured to perform computation and that is capable of sending and receiving data communications by way of one or more wired and/or wireless communication interfaces. Such devices may be configured to communicate using any of a variety of network protocols. For example, wired computing device 106 can be configured to execute a browser application that employs HTTP to request information from a web server and then displays the retrieved information to a subscriber.

Networks 108-109 are configured to couple one computing device to another computing device to enable them to communicate data. Networks 108-109 are generally enabled to employ any form of computer-readable media for communicating information from one electronic device to another. Each of networks 108-109 may include one or more of a wireless network, a wired network, a local area network (LAN), a wide area network (WAN), a direct connection such as through a Universal Serial Bus (USB) port, and the like, and may include the set of interconnected networks that make up the Internet. On an interconnected set of LANs, including those based on differing protocols, a router acts as a link between LANs, enabling messages to be sent from one to another. Communication links within LANs typically include twisted wire pair or coaxial cable. Communication links between networks may generally utilize analog telephone lines, full or fractional dedicated digital lines including T1, T2, T3, and T4, Integrated Services Digital Networks (ISDNs), Digital Subscriber Lines (DSLs), wireless links including satellite links, or other communication links known to those skilled in the art. Remote computers and other electronic devices may be remotely connected to LANs or WANs by way of a modem and temporary telephone link. In essence, networks 108-109 may include any communication method by which information may travel between computing devices.

The media used to transmit information across communication links as described above illustrate one type of computer-readable media, namely communication media. Generally, computer-readable media include any media that can be accessed by a computing device. Computer-readable media may include computer storage media, network communication media, and the like. Moreover, communication media typically embody information comprising computer-readable instructions, data structures, program components, or other data in a modulated data signal such as a carrier wave, data signal, or other transport mechanism, and such media include any information delivery media. The terms “modulated data signal” and “carrier-wave signal” include a signal that has one or more of its characteristics set or changed in such a manner as to encode information, instructions, data, and the like, in the signal. By way of example, communication media include wired media such as twisted pair, coaxial cable, fiber optic cable, and other wired media, and wireless media such as acoustic, RF, infrared, and other wireless media.

Framework for Healthcare Services

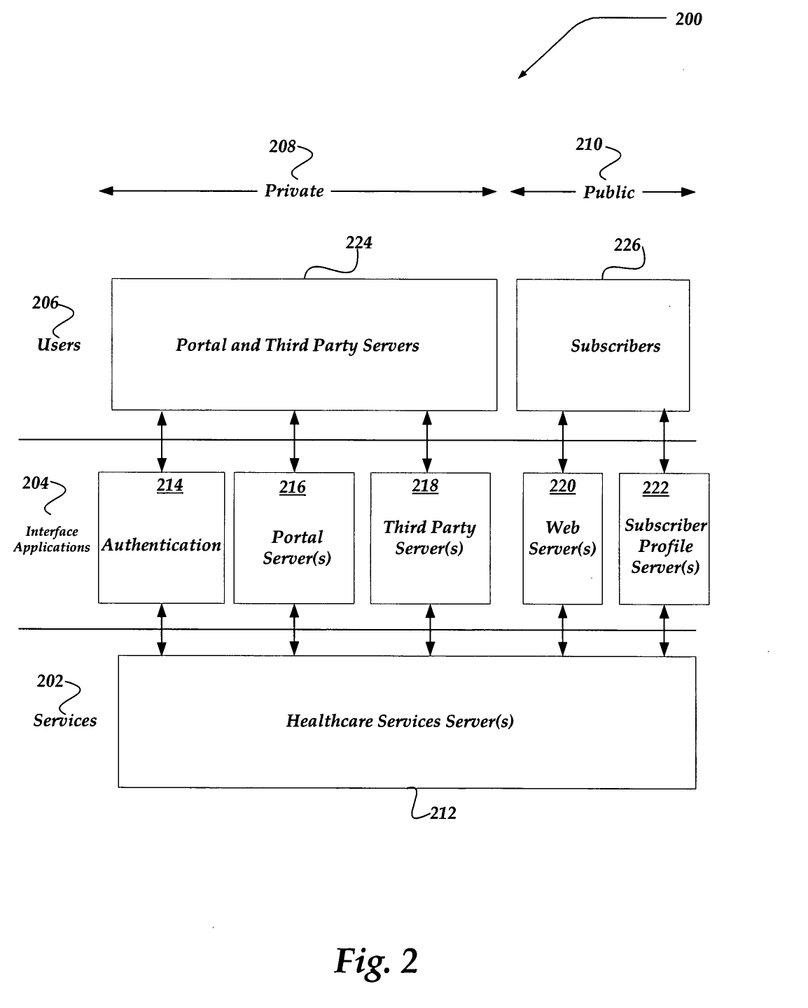

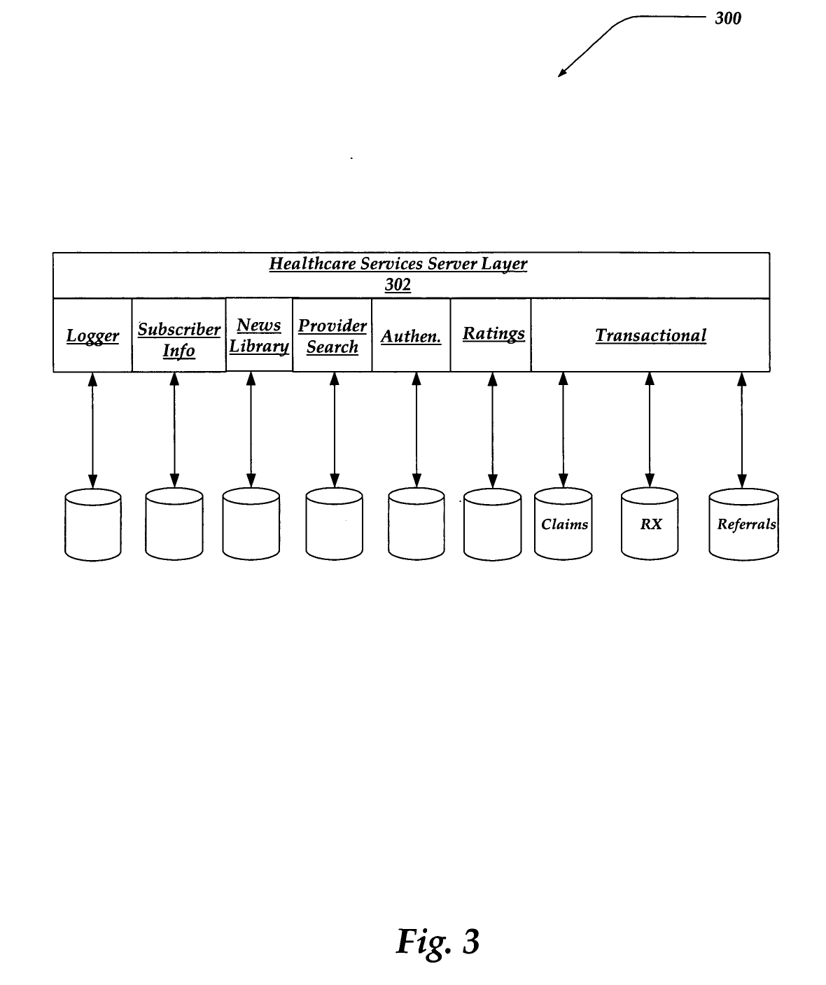

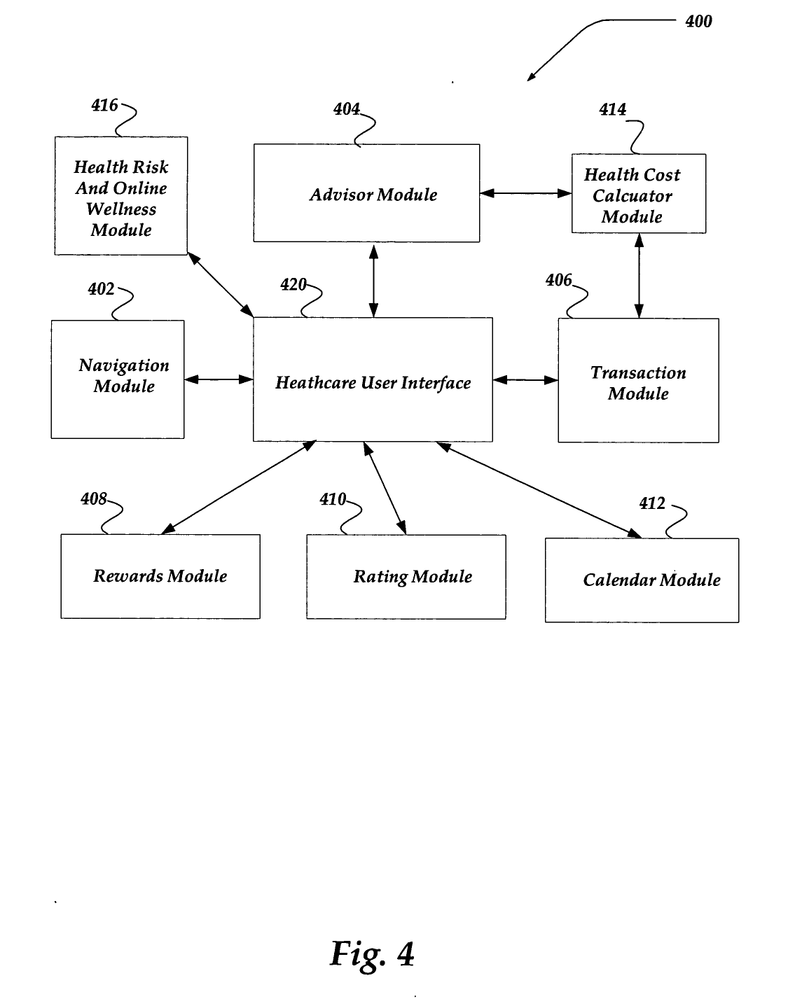

FIG. 2 illustrates elements of a multiple-tiered framework 200 for providing healthcare services that may form the basis of a system implementing the present invention. Framework 200 includes three layers or tiers: services 202 at the lowest tier, applications 204 in the middle, and users 206 at the highest tier. Services 202 include healthcare services 212, details of which are illustrated further in FIGS. 3-4. Applications 204 interact with healthcare services 212 and include, for example, authentication interfaces 214, Portal server(s) interfaces 216, third-party server interfaces 218, web servers 220, and subscriber profile server 222.

Authentication interfaces 214, portal server interfaces 216, and third-party server interfaces 218 interact at the users level 206 with portal servers and third party servers 224. Servers belonging to portal servers and third party servers 224 enable access to information regarding healthcare products and services provided by third party vendors, web sites promoting the gathering of wellness information regarding activities and/or events, healthcare references and news, and any other source of healthcare information that might be of interest to a subscriber. Web servers 220 and subscriber profile server 222 interact with individual subscribers 226 who request access to information regarding their personal healthcare benefits and wellness.

At interface applications tier 204 and user tier 206 tier, framework 200 can be regarded as divided into a private 208 component and a public 210 component. The private component 208 includes portal servers and third party servers 224 which interact with authentication interface 214, portal server interface 216, and third-party interface 218. The public component 226 includes subscribers 226, which interact with web servers 220 and user profile servers 222. The private 208 and public 210 components correspond to the private and public networks 108 and 109, respectively, illustrated in FIG. 1.

FIG. 3 illustrates healthcare services server layer 300 that may be implemented with one or more servers as generally disclosed in FIGS. 2 and 1. In the exemplary embodiment, layer 300 employs software libraries, applications, and/or interfaces for providing access between the various underlying healthcare services to the higher-level tiers, such as interface applications tier 204 and user tier 206 as shown in FIG. 2.

As shown in FIG. 3, layer 300 provides access to several underlying healthcare services, including (1) a “logger” service for logging the actions of each subscriber interacting with the healthcare services server; (2) a subscriber information service for providing detailed information about the actions and preferences of a particular subscriber; (3) a news and/or library service for providing wellness information whose content and delivery can be customized for each subscriber; (4) a provider search interface that enables a subscriber to search for the contact information for a medical professional based on different factors such as location, type, and coverage under the subscriber's healthcare insurance; (5) an authentication service for validating and authenticating that the “users” are who they claim to be; (6) a ratings service for enabling a subscriber to both review ratings provided by other subscribers regarding healthcare providers, services and products, and also provide their own rating; and (7) a transactional service for providing subscriber access to claims (pending and/or paid), prescriptions (paid and/or paid), and referral status (approved, pending and/or denied). Additionally, these services are configured to interact with and expose their functionality for use with a healthcare user interface, the details of which are described below in connection with FIG. 4.

FIG. 4 illustrates an exemplary arrangement of underlying functional modules for healthcare services web site 400 which enable customized rewards to be provided to a subscriber for affirmative healthcare actions. As shown in FIG. 4, several functional modules are in communication with site 400, including user interface module 420, navigation module 402, advisor module 404, transaction module 406, rewards module 408, rating module 410, calendar module 412, and Health Risk and Online Wellness Mobile 416. Also, healthcare cost calculator module 414 is arranged to operate with at least transactions module 406 and advisor module 404.

By accessing user interface module 420, a subscriber can interact with the functionality of the various modules. For example, transaction module 406 can provide subscriber access to information regarding insurance benefit claims, prescription claims, and/or referral status. Also, the subscriber can employ calculator module 414 to calculate various costs, such as total benefits paid out versus premiums paid over a selectable period of time.

Similarly, advisor module 404 enables the subscriber to employ calculator module 414 to determine costs versus benefits for different types of healthcare options and wellness activities. Advisor module 404 can also provide generic costs for different types of healthcare options, such as recommending a particular plan based on personal healthcare information and/or aggregated information from other similarly situated subscribers.

Navigation module 402 provides a subscriber with information regarding corporate processes at the healthcare insurance company, such as how to get a referral or how to get a reimbursement for medical expenses. Navigation module 402 can also can be arranged to provide an explanation of benefits for previously submitted claims under a particular subscriber's healthcare insurance policy.

Rating module 410 enables a subscriber to subjectively and/or objectively provide a personal rating or ranking of healthcare facilities, providers, services, and products. A subscriber's personal ratings can be privately listed. However, they can also be included in a normalized rating that is available to other subscribers. The normalized ratings are based at least in part on the aggregation of ratings provided by other subscribers in regard to the healthcare facilities, providers, services, and/or products.

Reward module 408 provides a reward to a subscriber for affirmative actions regarding wellness information and healthcare insurance. For instance, points can be accumulated for a subscriber's actions such as reviewing the status of a referral request, browsing an article on wellness, calculating costs for different healthcare benefits, paying a premium on time, logging onto the user interface, and the like. The points/rewards can be redeemed for a variety of different items and/or services, including, but not limited to, coupons, gift certificates, rebates, frequent flyer miles, discounts, prizes, money, rebates, ring tones, music, pictures, screensavers, and the like.

Calendar module 412 provides a graphical calendar interface for accessing wellness information and tracking a subscriber's actions in regard to healthcare. For example, calendar module 412 can graphically include the number of points earned on particular days, premium due dates, claim payment dates, and referral approval dates. The calendar module can also provide access to wellness event dates such as health fairs, foot races, exercise classes, stress reducing activities, and the like.

Health Risk and Online Wellness module 416 provides an interface that enables a subscriber to take an online personalized health risk assessment. Also, this module enables a subscriber to participate in online wellness programs. For example, the online wellness programs could provide information and/or access to suggested wellness activities, and enable a subscriber to track personal weight loss and exercise. Additionally, lifestyle factors, age, sex, blood pressure, and medical test results could be employed to provide a personalized health risk assessment for a particular subscriber.

Flow Charts

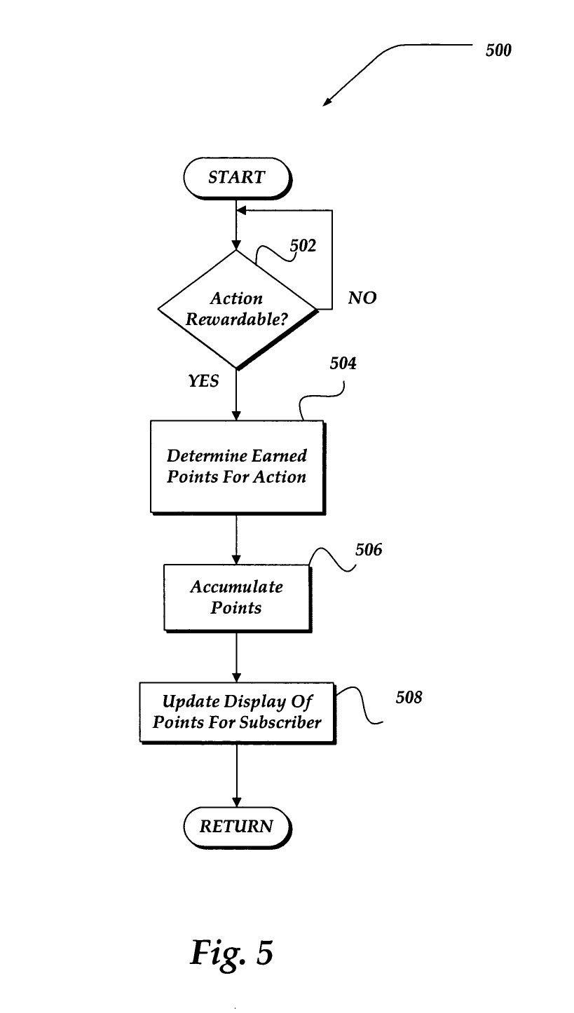

FIG. 5 illustrates a flowchart for process 500 for rewarding a subscriber for healthcare related actions. Moving from a start block, the process advances to decision block 502 where a determination is made as to whether or not a subscriber has performed an action that is rewardable. This action might be gathering wellness information, reviewing healthcare insurance benefits, participating in a healthcare survey, rating a healthcare service, product and/or facility, checking on the status of a referral, and the like. The process loops at decision block 502 until the determination is affirmative, and then moves to block 504 where a determination is made as to how many points have been earned for the rewardable action.

Stepping to block 506, the earned points are accumulated along with any other points that the subscriber may have previously earned. Advancing to block 508, a display of the number of earned points for the subscriber is updated with the current total. Next, the process returns to performing other actions.

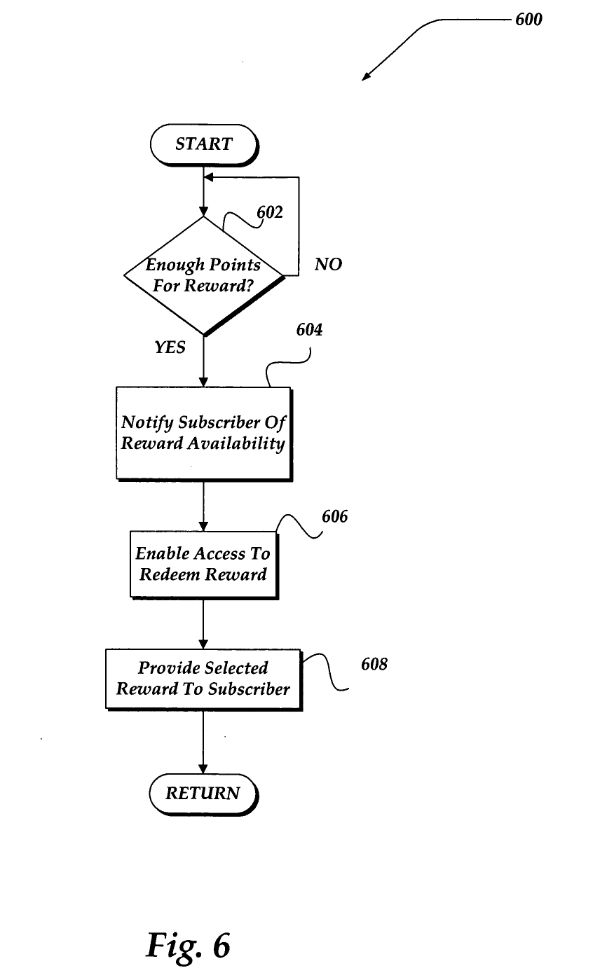

FIG. 6 shows a flowchart for process 600 for redeeming a reward for points earned by a subscriber for actions related to healthcare and/or wellness. Moving from a start block, the process advances to decision block 602, where a determination is made as to whether or not a subscriber has accumulated/earned enough points to redeem a reward. The process loops at decision block 602 until the determination is affirmative, and then moves to block 604 where a notification is provided to the subscriber of the availability of a reward for redemption. The notification may be provided to the subscriber in different ways, such as an email, text message, alert, announcement, voice message, instant message (IM), postcard, newsletter, letter, and the like.

At block 606, the process enables access to a mechanism for the subscriber to redeem the reward. One embodiment of the mechanism provides the subscriber with access to an electronic listing of the available rewards, and enabling the subscriber to select a reward for redemption from the listing. In another embodiment, a document can be physically mailed to the subscriber indicating each reward that is redeemable. At a later date, the subscriber could select a reward for redemption either by return mail or navigating a browser to a healthcare services web site.

The process moves to block 608 where the selected reward is provided to the subscriber. The reward can be provided in almost any form, including, but not limited to, coupons, gift certificates, rebates, frequent flyer miles, discounts, prizes, money, ring tones, music, pictures, screensavers, and the like. Next, the process returns to performing other actions.

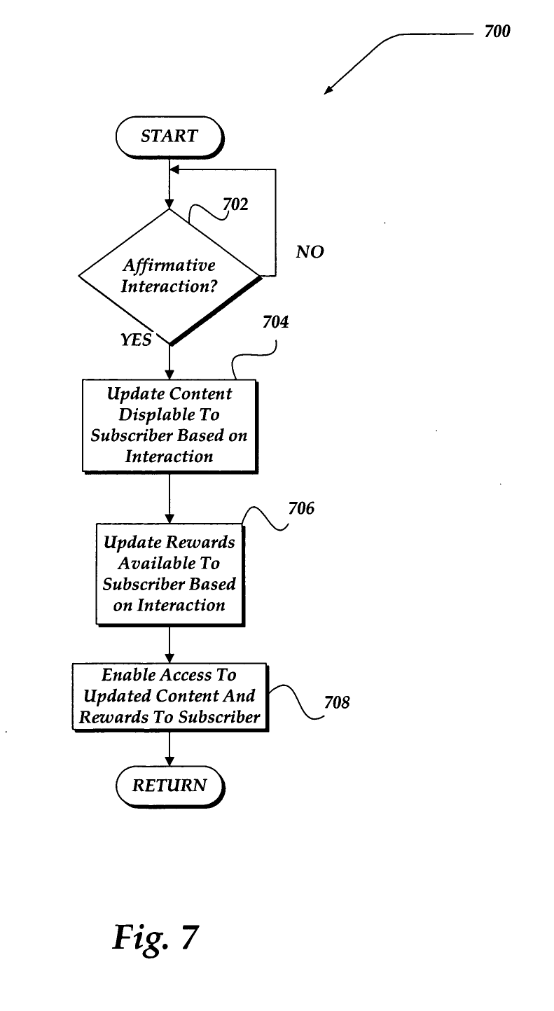

FIG. 7 illustrates a flowchart for process 700 for updating content for a healthcare services web site for a particular subscriber. Moving from a start block to decision block 702, where a determination is made as to whether or not a subscriber has performed an affirmative interaction with the healthcare services web site. The process loops at decision block 702 until the determination is true, and then moves to block 704 where content displayable to the subscriber is updated based on the interaction. For example, if the subscriber accessed an article regarding a foot race, other articles regarding running might be more prominently featured on the web site. Also, content can also be updated based on a subscriber's profile, historical behavior/interaction, age, preference, occupation, gender, family status, locale, and the like.

At block 706, the process updates the rewards available for redemption by the subscriber based at least in part on affirmative interaction with the content and/or functionality of the healthcare services web site. For example, if the affirmative interactions were in the context of gathering information regarding running, rewards could be updated to include a coupon for participating in a foot race or a discount on running shoes.

Advancing to block 708, the process enables subscriber access to the updated content and updated rewards at the healthcare services web site. Next, the process returns to performing other actions.

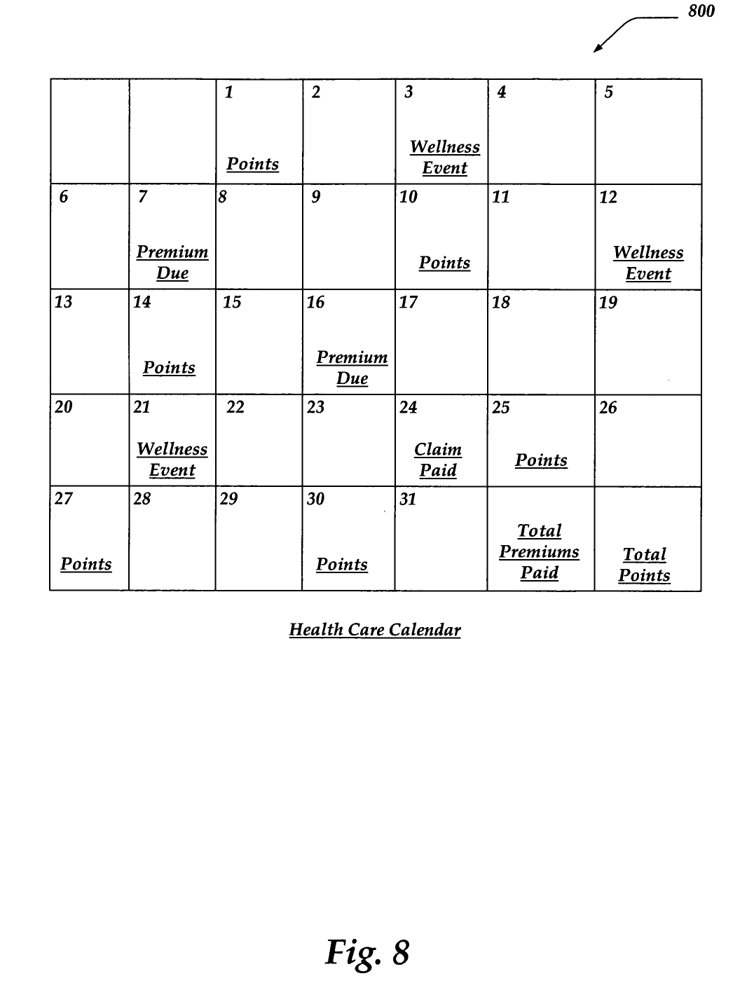

FIG. 8 shows an exemplary calendar interface for a healthcare services web site that can graphically include the number of points earned on particular days, premium due dates, claim payment dates, and referral approval dates. The calendar can also provide access to wellness event dates such as health fairs, foot races, exercise classes, stress reducing activities, and the like. In one embodiment, the content of the calendar is updated based on the subscriber's profile and affirmative interactions with content, reward redemption, and other functionalities on the healthcare services web site.

The above specification provides a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A method for rewarding a health related activity by a subscriber of health care insurance, the method performs actions comprising:
providing access to information regarding at least one transaction with the subscriber's health care insurance;
providing access to wellness information regarding the subscriber;
in response to at least one action by the subscriber regarding the transaction information and wellness information, providing access to at least one redeemable reward to the subscriber.

2. The method of claim 1, further comprising notifying the subscriber of the redeemable reward, wherein the notifying employs at least one of an email, text message, alert, announcement, voice message, instant message (IM), postcard, newsletter, and letter.

3. The method of claim 1, wherein the redeemable reward is at least one of a coupon, gift certificate, rebate, frequent flyer miles, discount, prize, money, ring tone, music, picture, and screensaver.

4. The method of claim 1, further comprising enabling a subscriber to subjectively rate at least one of a healthcare facility, healthcare provider, healthcare service, and healthcare product.

5. The method of claim 1, further comprising enabling a subscriber to objectively rate at least one of a healthcare facility, healthcare provider, healthcare service, and healthcare product.

6. The method of claim 1, further comprising enabling a subscriber access to at least one rating for a healthcare facility, healthcare provider, healthcare service, and healthcare product, wherein the rating is normalized based on a ranking provided by at least one of the subscriber and another subscriber to the healthcare insurance.

7. The method of claim 1, further comprising including content relevant to the subscriber in a calendar interface, wherein the content includes at least one of wellness information and healthcare insurance information.

8. The method of claim 1, further comprising updating content for display to the subscriber based at least in part on the affirmative interactions of the subscriber, wherein the content includes at least one of wellness information and healthcare insurance information.

9. The method of claim 1, further comprising displaying content for the subscriber based at least in part on at least one of profile, historical interaction, age, preference, occupation, gender, family status, health risk assessment, and locale, wherein the content includes at least one of wellness information and healthcare insurance information.

10. The method of claim 1, wherein the actions are performed at least in part on a mobile device.

11. The method of claim 1, wherein the actions are enabled at least in part by executable data included on a processor-readable medium.

12. A server for rewarding a health related action by a subscriber of health care insurance, comprising:
a memory for storing instructions; and
a processor for executing the instructions, the executed instructions enabling actions, including:
enabling access to information regarding at least one transaction with the subscriber's health care insurance;
enabling access to wellness information regarding the subscriber; and
in response to at least one action by the subscriber regarding the transaction information and wellness information, enabling access to at least one redeemable reward to the subscriber.

13. The server of claim 12, wherein the actions further comprise notifying the subscriber of the redeemable reward, and wherein the notifying employs at least one of an email, text message, alert, announcement, voice message, instant message (IM), postcard, newsletter, and letter.

14. The server of claim 12, wherein the redeemable reward is at least one of a coupon, gift certificate, rebate, frequent flyer miles, discount, prize, money, ring tone, music, picture, and screensaver.

15. The server of claim 12, wherein the actions further comprise:
enabling the subscriber to rate at least one of a healthcare facility, healthcare provider, healthcare service, and healthcare product; and
enabling the subscriber access to at least one rating for a healthcare facility, healthcare provider, healthcare service, and healthcare product, and wherein the rating is normalized based on a ranking provided by at least one of the subscriber and another subscriber to the healthcare insurance.

16. The server of claim 12, wherein the actions further comprise including content relevant to the subscriber in a calendar interface, and wherein the content includes at least one of wellness information and healthcare insurance information.

17. The server of claim 12, further comprising displaying content for the subscriber based at least in part on at least one of a current subscriber interaction, profile, historical interaction, age, preference, occupation, gender, family status, health risk assessment, and locale, wherein the content includes at least one of wellness information and healthcare insurance information.

18. The server of claim 12, further comprising a user interface for a healthcare services web site, wherein the user interface is accessible to at least one subscriber of the healthcare insurance.

19. The server of claim 12, further comprising an interface to at least one of a portal or third party server, wherein content for displaying to at least one subscriber is provided by the portal or third party server.

20. A client for rewarding a health related action by a subscriber of health care insurance, comprising:
a memory for storing instructions; and
a processor for executing the instructions, the executed instructions enabling actions, including:
enabling access to information regarding at least one transaction with the subscriber's health care insurance;
enabling access to wellness information regarding the subscriber; and
in response to at least one action by the subscriber regarding the transaction information and wellness information, enabling access to at least one redeemable reward to the subscriber.
